(19) United States
(12) Patent Application Publication
(10) Pub. No.: US 2010/0194691 A1
(43) Pub. Date: Aug. 5, 2010

(54) Dialogue System for a Motor Vehicle

(75) Inventor: Hermann Kuenzner, Freising (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/761,305

(22) Filed: Apr. 15, 2010

Related U.S. Application Data
(63) Continuation of application No. PCT/EP2008/008747, filed on Oct. 16, 2008.

(30) Foreign Application Priority Data
Oct. 25, 2007 (DE) 10 2007 051 035.9

(51) Int. Cl. G06F 3/02

(52) U.S. Cl. 345/172

(57) ABSTRACT

In a dialog system, which is intended for a motor vehicle and comprises a plurality of control keys, at least one of which can be assigned a function from a predefined set of functions in such a manner that this function is executed upon actuation of this control key, and the control key can be assigned to have one setting profile that is effective for the execution of a plurality of different functions.

### CROSS-REFERENCE TO RELATED APPLICATIONS

This application is a continuation of PCT International Application No. PCT/EP2008/008747, filed Oct. 16, 2008, which claims priority under 35 U.S.C. §119 from German Patent Application No. DE 10 2007 051 035.9, filed Oct. 25, 2007, the entire disclosures of which are herein expressly incorporated by reference.

### BACKGROUND AND SUMMARY OF THE INVENTION

The invention relates to a dialog system, which is intended for a motor vehicle and comprises a plurality of control keys, at least one of which can be assigned a function from a predefined set of functions in such a manner that this function is executed upon actuation of this control key.

Certain dialog systems are known, for example, from DE 10 2004 058 954 A1. It is known to configure the control keys of such a dialog system in such a manner that they can be assigned navigation destinations, telephone numbers, radio stations and/or audio sources. Strictly speaking, the assignment variables (navigation destinations, telephone numbers and/or radio stations) represent a parameter of a function that is to be executed. For example, when a control key which has been assigned a navigation destination is actuated, a route guidance (=function) to the navigation destination (=parameter) is initiated. Depending on the technical implementation, the control key may be assigned only the parameter when the control key (for example, route guidance in the case of a navigation destination) is actuated. In this case, the suitable function may be determined by means of the category of the parameter. Alternatively, both the function and the parameter may be assigned to the control key. Moreover, dialog systems in which a control key is assigned only one such parameter (e.g., by means of information technology) may be included in the aforementioned genre, insofar as owing to the category of the parameter they are effectively also assigned a function that is suitable for utilizing said parameter.

One aspect of the invention is to provide a dialog system that further enhances the operator control convenience that can be achieved through the unrestrained assignment of the control keys.

This aspect may be achieved with a dialog system exhibiting the features disclosed in claim 1. Further embodiments are apparent from the dependent claims.

According to one or more embodiments of the invention, the control key may be assigned, instead of a function, a setting profile, which is not directly related to a function. Rather, the setting profile assigned to the control key may be effective for executing a plurality of different functions.

The setting profile can include a single setting value or a plurality of setting values. The number of setting values included in the profile can also be variable as a function of the state of assignment. For example, it may be possible to assign up to four sound setting values to one control key. However, if the operator has assigned only two setting values to such a control key, then the setting profile comprises only two setting values. Similarly, the number of relevant setting values can vary as a function of the category of the setting values. If, for example, the control key is assigned sound settings, then the sound profile may comprise up to five setting values (volume, bass, treble, balance, fade). In contrast, if the control key is assigned the settings of the map view of a navigation system, then in certain navigation systems two setting values (scale and orientation of the map) may define the view.

Another aspect of the invention is to allow an operator to provide, in a very easy and fast way, settings that otherwise would have to be made in a very laborious and lengthy manner using, for example, a menu. In the case of vehicles, heretofore the operator would have to use a menu to navigate through many settings using a multi-functional operating element, such as a rotary/pressure actuator. The principles of the invention make it possible to significantly reduce the time needed for changing the settings. However, the principles of the invention should also be regarded as advantageous even if the interior of the vehicle has dedicated operating elements for changing the settings.

The principles of the invention are based on the idea that the optimal setting value of many settings, which are usually made by one user of the vehicle, is very situation dependent. For example, many operators may desire to increase the volume of the rear speakers of the vehicle stereo system if they alone are the users of the vehicle and/or only the driver's seat and the front passenger seat are occupied. If, on the other hand, passengers are also seated on the back seats of the vehicle, then at such a setting the volume level is too high for them. Therefore, it may be desirable to have the possibility of quickly activating a setting profile, which is suited for the presence of passengers on the back seats of the vehicle. During the next trip without passengers on the back seats, it is advantageous to have the possibility of easily activating a setting profile that is suited for such trips.

In certain embodiments, the setting profile may relate to continuously or quasi-continuously definable setting parameters, for example, a spatial sound distribution. In conventional systems, many continuously or quasi-continuously definable setting parameters are defined in many cases in an iterative manner over a prolonged period of time. In the case of a dialog system, according to one or more embodiments of the invention, a suitable setting may be found initially in the same way. However, a setting profile that is perceived to be suitable for a certain situation may be preserved and allowed to be re-activated in a simple way in situations that are comparable from the user's viewpoint.

Another aspect of the invention is based on the idea that, in certain situations, an operator may prefer many settings, in particular sound based settings, in general—and not just based on certain functions. Therefore, the setting profile which can be assigned to a control key, may be effective for a plurality of different functions in which the setting values included in the setting profile have relevance.

The setting values that are included in the setting profile may relate in particular to the manner of the sound reproduction. However, the setting values may also relate to the viewing mode of the screen. The support of the assignment of setting values with respect to these two main points of a function execution may be regarded—either separately or combined—as desirable.

According to one or more embodiments of the invention, the setting profile includes at least one setting value for the sound reproduction. The users of motor vehicles often set in a protracted iterative manner the volume and/or the treble and/or the bass and/or the spatial sound distribution of the audio system of a motor vehicle to a value that is adequate for the situation. The principles of the invention allow the setting values, which the operator perceived to be suitable in an earlier comparable situation and which the operator assigned to a control key, to be retrieved in a simple way. The only technical requirement is that the dialog system must be suited to the assignment of such setting profiles to control keys.

According to one or more embodiments of the invention, the setting profile includes at least one setting value that relates to a muting of the sound reproduction. A good many vehicles do not have a key for a temporary muting of the sound reproduction in order to avoid an excessive number of single operating elements. An operator, who misses such an operating element, can configure a control key as a key for muting the sound reproduction, in accordance with the principles of the invention.

As an alternative or in addition, the setting profile may also include at least one setting value for a screen display. In order to prevent being unduly distracted from the surrounding traffic, it is important that the screen displays may be quickly interpreted by the operator. The distraction time is minimized if a screen view that is used is one that the operator expects and/or prefers (e.g., a specific map scale of a navigation map and/or a certain map orientation (pointing in the direction of travel or pointing north) of a navigation map and/or a certain selection and/or sequence of screen contents in the display of a vehicle computer). The possibility of assigning such settings to a control key allows the operator to create, with the touch of a button, the suitable conditions for a slight diversion from the traffic situation.

One or more embodiments of the invention can be implemented so as to be especially advantageous by configuring the dialog system in such a way that the current assignment of the control key can be indicated in response to an operator request. Hence, the operator can be informed by the request operation as to what the consequence of actuating the control key will be and/or would be.

The request operation may include, for example, softly touching the control key, gently tapping the control key or the operator's hand moving near the control key, if the dialog system is capable of detecting such a contact, such tapping and/or such an approach.

The following disclosure relates to an embodiment in which the operator can interact with an assigned control key.

In response to a first request operation performed by an operator, a pointer to the assignment of a setting profile may be displayed. For example, for this purpose the output may be a short description in text mode, for example, “individual settings.” In response to the first request operation, the output may also be, if desired, a pointer to the category of the setting parameters, contained in the setting profile, for example, “individual sound settings” or “individual spatial sound distribution.” Even a symbol and/or a color of a screen element can indicate such a category. Similarly, in response to the first request operation the output may be a pointer to a certain setting parameter, contained in the setting profile, for example, “individual volume setting.” However, it may also be the case that in responding to an additional second request operation performed by the operator is also at least one setting value (e.g., contained in the setting profile) displayed. Such setting value may be, for example, “individual sound settings: volume 7, bass +1, treble +1, balance 0, fade −2.” Thus, the operator is confronted with the detailed information of the setting values, contained in the setting profile, only if he retrieves them specifically by means of the additional second request operation.

Touching the control key may be defined as the first request operation, for example. Maintaining the contact over a defined period of time (e.g., 2 seconds) may be defined as the second request operation.

The assignment of the setting profile to the control key may be performed by an operator's assignment operation that corresponds to an operating action that is well known in conjunction with the assignment of functions to control keys. For example, it may be provided that depressing the control key for a long time (for example, longer than 2 seconds) causes an assignment of the control key.

Special effects and advantages can be achieved by a targeted control of the contents, which are actually assigned to the control key in response to the operator's assignment operation (for example, longer press).

In the case of an operator's assignment operation during the display of a setting menu by means of an optical display unit of the dialog system, at least one setting value (e.g., contained in the setting menu) may be assigned to the control key. In such a design, the assignment of settings can be executed exclusively during the display of a setting menu, according to certain embodiments. During the execution of a function (for example, navigation) without the current display of a setting menu, an assignment operation performed by the operator may result, if desired, in the assignment of the currently executed function to the control key. Restricting the assignment of setting values to the case of the display of a setting menu largely eliminates the risk of the operator being uncertain as to what the consequence of an assignment operation in the current situation would probably be.

The assignment of the control key, as described above, should not be confused with the subsequent retrieval of stored setting(s) by actuating the control key. This retrieval is possible preferably in any operating state of the dialog system and, in certain embodiments, at least independently of the display of a setting menu.

Furthermore, it is suitable to define just exactly what will be assigned to the control key in response to an assignment operation.

Another aspect of the invention provides that in response to the assignment operation, performed during the display of a setting menu, the control key may be assigned only one setting value, which may be visually highlighted in the setting menu. In this manner, the control key may be assigned in a highly targeted way to a single setting value. This feature may be desirable if at least one setting value (e.g., bass), which was already included in the setting profile assigned to the control key, stays even after this new assignment, and at least one setting value (e.g., treble), which was newly assigned to the control key, is added to the setting profile. In this manner, the operator can create and improve a setting profile in a very differentiated and/or customized way. The setting values that are currently contained in the setting profile can be checked in-between times by means of the aforementioned request operation(s).

According to one or more embodiments of the invention, the dialog system can comprise a logic system that prevents the addition of setting values that are incompatible with a setting profile. For example, a setting value that relates to a screen view cannot be added to a sound setting profile.

According to one or more embodiments of the invention, the dialog system can comprise a logic system that, with the addition of certain setting values, automatically adds to a setting profile the complementary setting values. If, for example, a setting value for the treble of the audio system is added to a setting profile, then the currently applicable value for the bass of the audio system can also be automatically added.

Moreover, a menu-based management of the setting profiles assigned to control keys can be provided in the dialog system. This management can facilitate the renaming of the profiles and the modification or deletion of setting values contained therein.

A faster variant of the assignment of a plurality of setting values provides that, in response to an assignment operation performed during the display of a setting menu, all setting values contained in the setting menu are assigned to the control key. Analogous to a menu-based management of the setting profiles, a logic system of the above described type that prevents and/or automatically performs the addition of new setting values may also be provided in accordance with the principles of the invention.

Other objects, advantages and novel features of the present invention will become apparent from the following detailed description of one or more preferred embodiments when considered in conjunction with the accompanying drawing.

### BRIEF DESCRIPTION OF THE DRAWINGS

FIG. 1 depicts one embodiment of a vehicle configured in accordance with the principles of the invention.

### DETAILED DESCRIPTION OF THE DRAWINGS

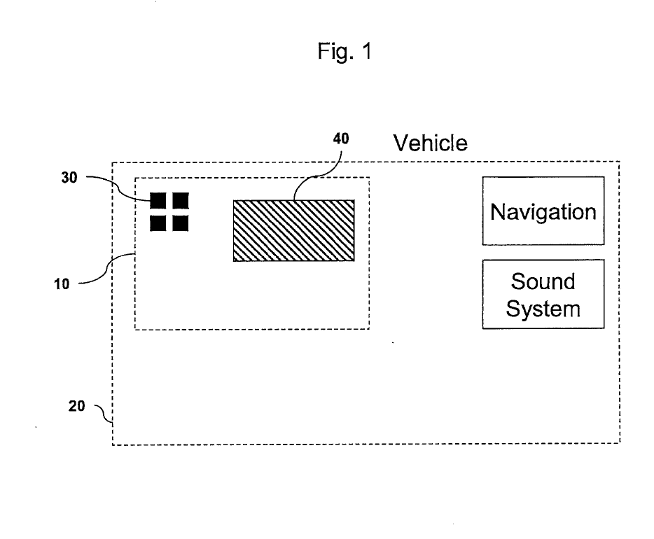

With reference to FIG. 1, a dialog system 10 in a motor vehicle 20 comprises a plurality of favorite keys 30 (and each individually a “key 30”) that can be assigned in a free and unrestrained way. These keys 30 can be assigned, inter alia, navigation destinations, radio stations, audio sources and telephone numbers. After a control key 30 is assigned such parameters, when the control key 30 is actuated the respective function is executed on the basis of the parameters. In the case of a navigation destination, a route guidance is executed, while in the case of an audio source the reproduction of the same, etc.

As an alternative, the same favorite keys 30 may be assigned a setting profile in a selective manner. The setting profile can comprise many setting values.

If a favorite key 30 is depressed for a prolonged period of time while in a setting menu, a specific setting parameter may be highlighted by a cursor and then the value of the setting parameter added to the setting menu, insofar as it does not conflict with any other setting values that are already contained in the profile. The latter would be the case if the profile already contains values that relate to a screen view, for example, and a value is supposed to be added that relates to a sound setting. In the present example, such incompatible values may not be combined in a common profile. If, nevertheless, the operator endeavors to add an incompatible setting value to an existing setting profile, then the interactive dialog may offers the operator one or more of the following options:

deleting the existing values that are causing the conflict,

selecting another control key 30 which is assigned a setting profile that does not contain any conflicting values,

creating a new profile for the favorite key 30 that is actuated for a prolonged period of time, and/or

creating a new profile for another favorite key 30.

If a new profile is created, then an interactive dialog may offer the operator the option of naming this profile with a short description. This short description may be displayed on a screen 40 of the dialog system 10 when the operator gently touches (but without actuating) the key 30 at a later date. If the key 30 is pressed for a longer period of time (e.g., longer than 3 seconds), then a list of setting values, contained in the setting profile, may be displayed on a screen 40 of the dialog system 10. The operator can rename an existing profile on the basis of a menu.

Similarly, individual values may be removed from a setting profile on the basis of a menu, and/or individual values in a setting profile can be changed, and/or an entire setting profile can be deleted, and/or an entire setting profile can be shifted to a different favorite key 30.

If a favorite key 30, which had been assigned a setting profile, is actuated, then all of the setting parameters to which the setting values contained in the setting profile relate, may be set to these setting values. The modified setting values are valid in all functions in which the corresponding setting parameters are relevant. Hence, a modified volume has an effect on both a CD reproduction as well as a radio reproduction.

In accordance with one or more embodiments, the retrieval and/or activation of a setting profile by actuating the corresponding favorite key 30 can be performed at any time after the assignment of the key 30. For example, the sound distribution of the audio reproduction can be changed by activating a corresponding setting profile that has been assigned to a favorite key 30, even if the single screen 40 of the dialog system 10 is currently displaying a map of a navigation system. Thereafter, however, there may be the option that the screen display 40 can be changed temporarily for a short period of time in order to display the modified setting values.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle dialog system comprising a plurality of control keys, where the plurality of control keys includes a control key assigned a function from a predefined set of functions such that the function is executed upon actuation of the control key, and wherein the control key can be selectively assigned a particular setting profile that is effective for the execution of a plurality of different functions.

2. A motor vehicle dialog system of claim 1, wherein the setting profile comprises at least one setting value for a sound reproduction.

3. A motor vehicle dialog system of claim 1, wherein the setting profile comprises at least one setting value for a screen display.

4. A motor vehicle dialog system of claim 1, wherein the setting profile comprises at least one setting value for the volume of the sound reproduction.

5. A motor vehicle dialog system of claim 1, wherein the setting profile comprises at least one setting value for a muting of the sound reproduction.

6. A motor vehicle dialog system of claim 1, wherein the current assignment of the control key is displayed in response to a request operation of an operator.

7. A motor vehicle dialog system of claim 6, wherein when the control key is assigned a setting profile,
a pointer to the assignment of a setting profile is displayed in response to a first request operation, and
at least one setting value, contained in the setting profile, is displayed in response to a second request operation of an operator.

8. A method for assigning a control key for a dialog system comprising an assignment operation of the operator during the display of a setting menu by means of an optical display unit of the dialog system, wherein at least one setting value, contained in the setting menu, is assigned to the control key.

9. The method of claim 8, further comprising assigning a setting value, that is visually highlighted in the setting menu, to the control key.

10. The method of claim 8, further comprising assigning all of the setting values contained in the setting menu to the control key.

11. The method of claim 8, further comprising:
leaving at least one setting value, which was already contained beforehand in the setting profile assigned to the control key; and
adding at least one setting value, which was newly assigned to the control key, to the setting profile.

12. A method comprising the acts of:
assigning a control key, from a plurality of control keys, a particular function from a predefined set of functions;
assigning a setting profile to the control key, wherein the setting profile is applicable to a plurality of different functions; and
executing the function in response to actuation of the control key and in accordance with the setting profile.

13. The method of claim 12, wherein a current assignment of the control key is displayed in response to a request from an operator.

14. The method of claim 12, wherein assigning the setting profile to the control key further comprises:
displaying a pointer to the assignment of the setting profile in response to a first request operation; and
displaying at least one setting value, contained in the setting profile, in response to a second request operation.
